(19) United States
(12) Patent Application Publication
(10) Pub. No.: US 2014/0352473 A1
(43) Pub. Date: Dec. 4, 2014

(54) Gearwheel Arrangement Comprising a Spring Element

(71) Applicants: Walter Blaes, Fuessen (DE); Christoph Schreieck, Stanzach (DE); Herbert Soika, Seeg (DE)

(72) Inventors: Walter Blaes, Fuessen (DE); Christoph Schreieck, Stanzach (DE); Herbert Soika, Seeg (DE)

(21) Appl. No.: 14/367,815

(22) PCT Filed: Dec. 21, 2012
(86) PCT No.: PCT/DE2012/001218

§ 371 Date: Jun. 20, 2014

(30) Foreign Application Priority Data
Dec. 22, 2011 (DE) 10 2011 122 138.0

(51) Int. Cl. F16H 55/18; F16H 55/14

(52) U.S. Cl. CPC F16H 55/18; F16H 55/14
USPC 74/445

(57) ABSTRACT

A gearwheel arrangement that has a main gearwheel that has a hub is provided. The arrangement has a secondary gearwheel that has a receiving hole that receives the hub and is rotatable in a circumferential direction in relation to the main gearwheel. When the arrangement is in a mounting position the secondary gearwheel is secured in an axial direction. The arrangement may include a spring element that pretensions the secondary gearwheel in the circumferential direction. The spring element is completely enclosed within the gearwheel arrangement.

The invention relates to a gearwheel arrangement with the feature of the preamble of patent claim 1.

AT 508 701 A4 discloses a gearwheel arrangement with a main gearwheel and a secondary gearwheel which is rotatable relative to the latter in the circumferential direction. In order to secure the position of the rotatable secondary gearwheel in the axial direction on the main gearwheel, a securing element in the form of a “Seeger circlip ring” is provided. Said Seeger circlip ring engages in a peripheral securing groove of the hub.

Further gearwheel arrangements which in each case have two interconnected partial gearwheels can be gathered from U.S. Pat. No. 1,554,889 A, DE 10 2005 041 357 A1, DE 10 2009 015 953 A1 and WO 2012/040762 A1. The connection of the two partial gearwheels here can be designed in the manner of a bayonet catch.

The invention is based on the object of simplifying the design of a gearwheel arrangement of the type in question.

This object is achieved by the combination of features of independent patent claim 1.

According to the invention, in the mounting position, the secondary gearwheel is mounted for the axial securing thereof on the main gearwheel by means of a bayonet catch, wherein the bayonet catch is designed in such a manner that an axial hub free end of the hub extends in the axial direction at most as far as a surface plane of the outer end side (at least one section, segment, region or the like of said end side) of the secondary gearwheel, said end side facing axially away from the main gearwheel. This construction provides a design of the gearwheel arrangement saving space in the axial direction.

At the same time, the bayonet catch has securing elements which are arranged in a space-saving and mechanically stable manner in each case either on the hole wall of the receiving hole of the secondary gearwheel or on the radial outside of the hub of the main gearwheel, the outside forming an external casing. By this means, the hub and the receiving hole or the hole wall itself thereof, with an appropriate geometrical configuration, can also provide the bayonet catch in a space-saving manner in an additional function, and therefore further components can be dispensed with in a manner saving on space and facilitating the mounting. For example, a conventional Seeger circlip ring or similar components as a separate and additional component for the axial securing can also be dispensed with. Consequently, apart from the secondary gearwheel and/or the main gearwheel, components are not required for the axial securing. On the contrary, the axial securing or the bayonet catch is positioned to a certain extent axially within the gearwheel arrangement. This supports an axially short dimensioning of the hub. This arrangement makes it possible for the pair of gearwheels to be able to be used even in small construction spaces.

The relative rotatability of the two gearwheels (main gearwheel and secondary gearwheel) in relation to each other permits a noise-minimizing backlash compensation when the teeth of the gearwheel arrangement are in engagement with one or more further components, in particular further gearwheels. For the purpose of said backlash compensation, the gearwheel arrangement has a spring element, the spring force of which acts in the circumferential direction, and a reversible rotation and also pretensioning of the two gearwheels (main and secondary gearwheel) in relation to each other can be achieved. The spring element here is completely enclosed within the gearwheel arrangement and thereby additionally improves the compact, space-saving design of the gearwheel arrangement. In addition, the spring element itself is thereby effectively protected against possible damage, and this, in turn, supports a reliable operation of the gearwheel arrangement.

The combination
of the spring element which is completely integrated within the gearwheel arrangement, with
the securing elements arranged in each case on the hub or at the receiving hole, and with
the hub extending axially at most as far as the outer end side of the secondary gearwheel, said end side facing axially away from the main gearwheel
   permits a gearwheel arrangement in which no components protrude beyond the outer end faces or end sides of the main gearwheel and of the secondary gearwheel, which end faces or end sides face axially away from one another. This compact design improves a simple mounting of the gearwheel arrangement and simple handling thereof during installation in confined space conditions.

The body of the main gearwheel and of the hub thereof are in particular produced as a single piece, which supports a mechanically stable design of the gearwheel arrangement.

The hub preferably has a central recess for receiving a force-transmitting element, in particular a shaft.

The spring element is preferably designed in the manner of a ring and is completely enclosed in the form of what is referred to as a spring ring in an annular gap of the gearwheel arrangement. In particular, the annular gap is arranged on the body of the main gearwheel, and therefore the secondary gearwheel does not have to take into consideration any additional design height for the mounting of the spring element, with the effect of an axially flat design of the gearwheel arrangement.

In a preferred embodiment, a pretensioning of the secondary gearwheel in the circumferential direction and in particular also a limiting of the rotatability thereof in the circumferential direction are achieved in that the spring element has two open ring ends which are enclosed in the annular gap and are in each case supported on a supporting web within the gearwheel arrangement. In this case, the one support web is connected (in particular integrally) to the main gearwheel and the other supporting web is connected (in particular integrally) to the secondary gearwheel.

In a preferred embodiment, a flat profile at least of the axially outer end side or end face of the secondary gearwheel, as viewed along the radial direction, is realized, at least in the region of the main body of said gearwheel, apart from the teeth of the secondary gearwheel. Consequently, the outer end side or end face of the secondary gearwheel, which end side faces axially away from the main gearwheel, extends, at least in the region of the main body of said secondary gearwheel, in a single flat surface plane. By this means, during the mounting position of the gearwheel arrangement, the hub free end extends in the axial direction at most as far as the entire outer face of the previously mentioned axially outer end side of the secondary gearwheel at least in the region of the main body of the secondary gearwheel. This additionally supports the desired, structurally compact and space-saving design of the gearwheel arrangement.

The hub free end of the hub of the main gearwheel preferably ends flush with the axially outer end side of the secondary gearwheel such that step-like elevations or depressions on the gearwheel arrangement can be avoided on the outer side of the secondary gearwheel, as viewed along the radial direction.

The outer face of the teeth of the secondary gearwheel, which outer face is visible in the axial direction and runs in the radial direction, is preferably also at least partially or completely located in the surface plane of the axially outer end side of the secondary gearwheel.

A particularly flat and compact design of the gearwheel arrangement is possible if the two end sides or end faces of the main gearwheel and of the secondary gearwheel, which end sides or end faces face axially away from each other, run in each case in a single flat plane. In particular, said two planes are oriented in a plane-parallel manner to each other.

At least one securing element is preferably an integral part of the main gearwheel or of the secondary gearwheel. In particular, all of the securing elements are in each case an integral part of the main gearwheel or of the secondary gearwheel. In other words, the individual components of the bayonet catch are preferably in each case arranged integrally on one of the two gearwheels such that simple and time-saving mounting of the two gearwheels is possible. In addition, dispensing with further components for the axial securing has a space-saving and cost-saving effect. Furthermore, the integral nature also supports effective mechanical stability of the bayonet catch and of the axial securing between the two gearwheels.

The bayonet catch is in particular designed in such a manner that a securing element is designed either as a securing lug extending radially into the receiving hole or radially beyond the hub and, in the mounting position, is enclosed movably in the circumferential direction in a securing groove of the other gearwheel in each case. By means of this configuration, the bayonet catch is kept simple in terms of design and geometry, which facilitates the handling thereof during the mounting and also during removal.

A plurality of securing lugs distributed in the circumferential direction are preferably provided, as a result of which a uniform distribution of force is assisted during the axial securing.

The securing groove is advantageously designed so as to be closed per se in the circumferential direction and thereby assists a rotational securing of the two gearwheels on each other in a simple manner in terms of mounting.

In a preferred embodiment, the securing groove opens axially into a securing recess which is bounded in the circumferential direction by two side webs, wherein the securing recess is at least as large in the circumferential direction (i.e. in the angular dimension) as the securing lug. This geometrical configuration improves a secure engagement, in terms of mounting, of the two gearwheels in each other.

A plurality of securing recesses distributed in the circumferential direction are preferably provided. In particular, a securing lug can engage in one securing recess in each case, as a result of which, when there is a plurality of securing lugs, effective mounting guidance for a centered axial engagement of the two gearwheels in each other during the mounting is supported.

A space-saving configuration of the bayonet catch is advantageously supported if at least one of the side webs which bound the securing recess in the circumferential direction at the same time bounds the securing groove in the axial direction.

The securing lug or the securing lugs is or are preferably arranged on the hole wall of the receiving hole. For a geometrically simple design of the bayonet catch, in particular all of the securing lugs then project radially into the receiving hole. This simple design is furthermore supported by the corresponding securing groove preferably being arranged on the outer casing of the hub and being open radially outward.

The two gearwheels are preferably connected releasably to each other by means of the bayonet catch. Repairs to individual gearwheels of the arrangement are thereby more straightforwardly possible. In addition, an individual gearwheel can be exchanged or a non-damaged gearwheel can be recycled in a manner saving on raw material.

The rotatability of the secondary gearwheel in the circumferential direction in relation to the main gearwheel is advantageously limited, as a result of which an axial captive securing between the two gearwheels is supported in a simple manner in terms of construction. The rotatability is preferably limited by means of the spring element (already mentioned) for pretensioning the secondary gearwheel. The limiting or the largest possible desired angular dimension of the rotatability can be realized here by corresponding geometrical dimensioning of the spring element (for example thickness or width of the cross section of the spring body).

The supporting of the axial captive securing is preferably designed in such a manner that, in the mounting position, the angular dimension of the limited rotatability in the circumferential direction is smaller than the required angular dimension of the bayonet catch in the circumferential direction in order to release the connection between the two gearwheels. In an advantageous embodiment, the abovementioned limiting of the rotatability can be removed (for example by means of a removal device) in order to be able intentionally to undo the axial connection between the two gearwheels outside the operational use of the gearwheel arrangement.

If a securing lug is used as part of the bayonet catch, in the mounting position, the axial securing can be maintained in a simple manner in terms of construction and in a reliable manner by the angular dimension of the limited rotatability in the circumferential direction being smaller than the angular dimension which is required in the circumferential direction in order to return the securing lug into an associated securing recess. It is thereby ensured in a technically straightforward manner that at least one section of the securing lug always remains outside the securing recess in the circumferential direction and therefore forms an axial abutment against undesirable removal of the axial captive securing. Depending on the embodiment, in the mounting position, as viewed along the circumferential direction, the securing lug can be arranged with the full angular dimension thereof running in the circumferential direction or just with a portion of said angular dimension outside the securing recess.

The gearwheel arrangement is preferably used for transmitting force in the drive of assemblies (for example secondary assemblies, camshaft, driveshaft) in the region of a motor vehicle drive train. The gearwheel arrangement can advantageously be used even in particularly confined space conditions in the engine compartment of a motor vehicle.

The main gearwheel and/or the secondary gearwheel are preferably produced powder-metallurgically, i.e. by sintering (for example sintered steel).

The invention is explained in more detail with reference to the exemplary embodiments which are illustrated in the drawings, in which:

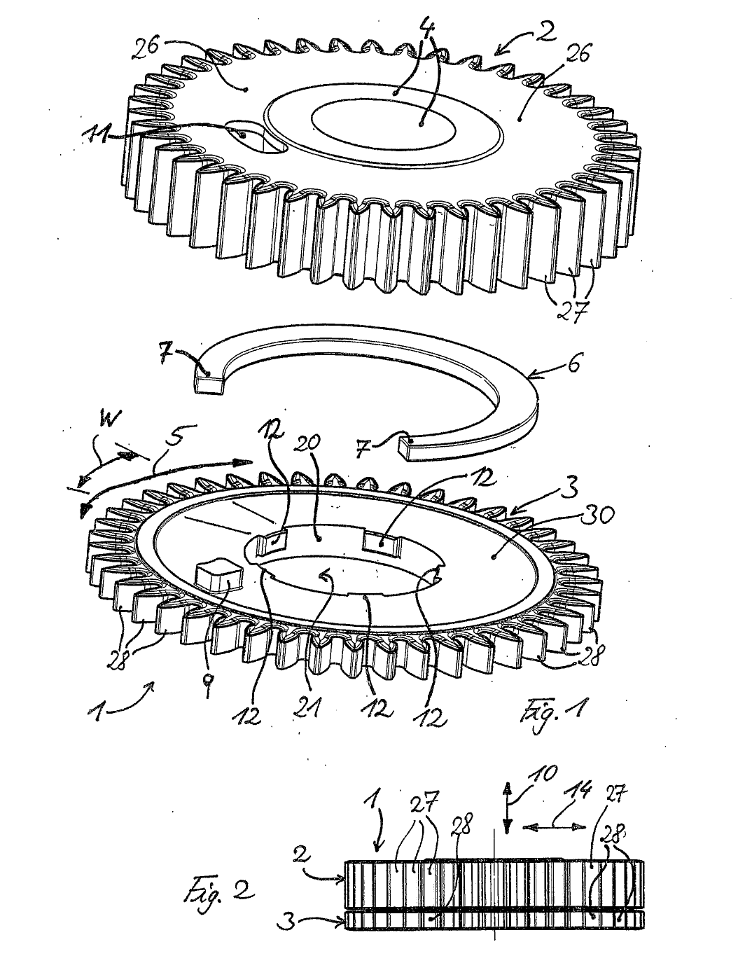

FIG. 1 shows a perspective exploded illustration of the gearwheel arrangement according to the invention,

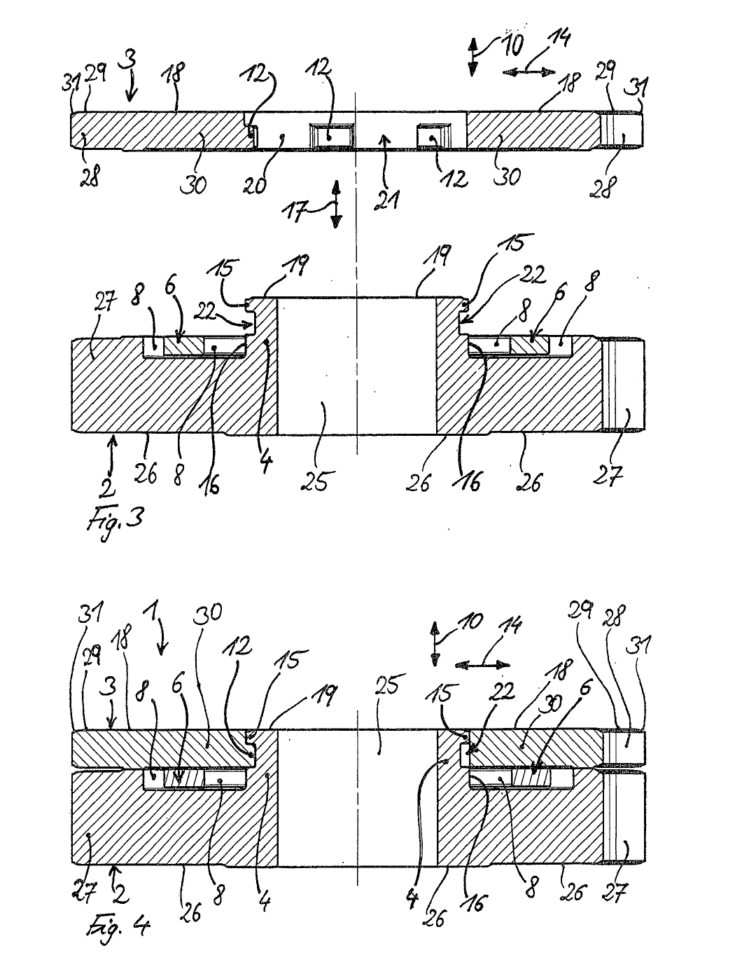

FIG. 2 shows the gearwheel arrangement according to FIG. 1 in a side view and in an assembled state of the two gearwheels,

FIG. 3 shows a sectional side view of the two gearwheels before the assembly,

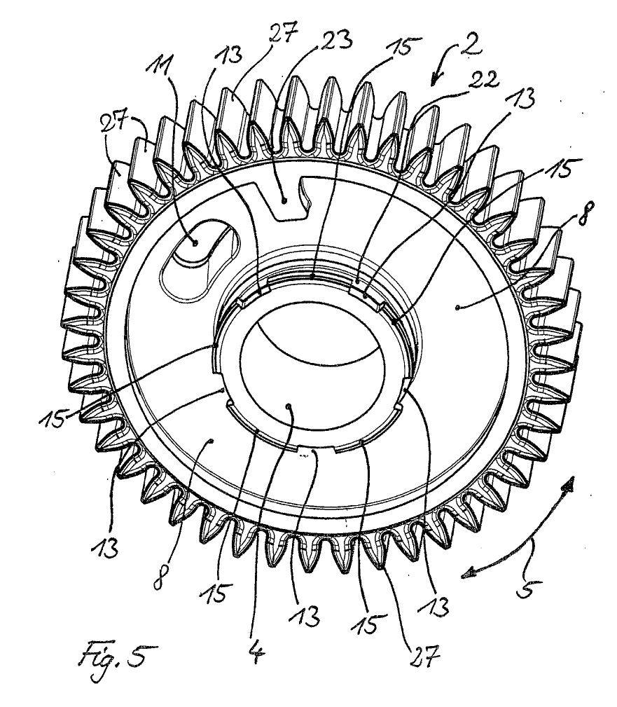

FIG. 4 shows the sectional side view of the two gearwheels according to FIG. 3 in the assembled state, and

FIG. 5 shows a perspective view from below of the main gearwheel.

The gearwheel arrangement 1 according to FIG. 1 has a main gearwheel 2 and a secondary gearwheel 3. The main gearwheel 2 is connected integrally to a hub 4 which supports the main gearwheel 2. A central recess 25 passes in the axial direction 10 through the hub 4. Said recess 25 can receive a force-transmitting component (not illustrated here), in particular a shaft (for example, camshaft, driveshaft, etc.). A radial direction 14 along which the two gearwheels 2, 3 extend radially runs transversely with respect to the axial direction 10. The teeth 27 of the main gearwheel are arranged on the radially outer region thereof, while the tooth 28 of the secondary gearwheel 3 are arranged in the radially outer region thereof.

In the mounting position (FIG. 2, FIG. 5), the two gearwheels 2, 3 are rotatable in a spring-elastic manner in the circumferential direction 5 in relation to each other. For this purpose, a spring ring 6 with two open ring ends 7 is placed into an annular gap 8 of the main gearwheel 2 (FIGS. 3, 4). The spring ring 6 is completely enclosed within the annular gap 8 and is thereby completely integrated within the gearwheel arrangement 1 in the mounting position of the gearwheel arrangement 1. One ring end 7 is supported in the circumferential direction 5 on a supporting web 9 of the secondary gearwheel 3 while the other ring end 7 is supported on a supporting web 23 of the main gearwheel 2. The supporting web 9 is an integral part of the secondary gearwheel 3. The supporting web 23 is an integral part of the main gearwheel 2 and is arranged in the region of the annular gap 8 (FIG. 5). In the mounting position of the gearwheel arrangement 1, the supporting web 9 of the secondary gearwheel 3 is enclosed in the annular gap 8. An actuating tool (not illustrated here) passes in the axial direction 10 through an elongated hole 11 in the main gearwheel 2 into the annular gap 8 where it maintains a relative position between the supporting web 9, the supporting web 23 and the ring ends 7 by the spring ring 6 being pretensioned in the circumferential direction 5, and therefore the secondary gearwheel 3 can be pretensioned in the circumferential direction 5 relative to the main gearwheel 2. The actuating tool has been removed in the operating state of the gearwheel arrangement 1.

In the mounting position of the gearwheel arrangement 1 (FIG. 2, FIG. 4), the secondary gearwheel 3 is mounted on the main gearwheel 2 in a manner secured in the axial direction 10. The axial securing has a plurality of securing elements. A plurality of securing lugs 12, a plurality of securing recesses 13, a plurality of side webs 15 and a securing web 22 are provided as securing elements. Said securing elements 12, 13, 15, 22 interact in the manner of a bayonet catch in such a manner that, in the mounting position (FIG. 2, FIG. 4), the two gearwheels 2, 3 are connected to each other in the manner of a bayonet catch.

The securing lugs 12 are connected integrally to the body of the secondary gearwheel 3 in the region of a hole wall 20 of a receiving hole 21 in the secondary gearwheel 3. The remaining securing elements 13, 15, 22 are an integral part of the main gearwheel 2 in the region of the hub 4.

According to FIG. 1, five securing lugs 12 are arranged on the hole wall 20 of the receiving hole 21 in the secondary gearwheel 3. The receiving hole 21 serves for receiving the hub 4 during and after the mounting of the two gearwheels 2, 3. The securing lugs 12 are spaced apart uniformly from one another in the circumferential direction 5 and project radially into the receiving hole 21. In the mounting position, the securing lugs 12 are enclosed in the securing groove 22 which is arranged on the radial outside 16 of the hub 4, the outside forming an outer casing, and runs in a manner closed per se in the circumferential direction 5. The securing groove 22 is open radially outward and opens axially into a total of five securing recesses 13. Said securing recesses 13 are spaced apart uniformly from one another in the circumferential direction 5 and are likewise arranged on the radial outside 16 (i.e. on the circumferential casing) of the hub 4. Said securing recesses serve for receiving one securing lug 12 in each case during the mounting of the two gearwheels 2, 3. Each securing recess 13 is bounded in the circumferential direction 5 by two side webs 15. The angular dimension of each securing recess 13 in the circumferential direction 5 is at least as large here as the corresponding angular dimension W of the associated securing lug 12. The side webs 15 act at the same time as axial boundaries of the securing groove 22 in the direction of the axial hub free end 19 of the hub 4. Some of the securing elements, namely the securing recesses 13 and the side webs 15, are arranged in the region of the hub free end 19 of the hub 4, as viewed in the axial direction 10.

During the mounting, the secondary gearwheel 3 and the main gearwheel 2 are moved toward each other in a relative manner axially in the transport direction 17. In the circumferential direction 5, the two gearwheels 2, 3 are arranged with respect to each other in such a manner that the securing lugs 12 of the hole wall 20 can pass through the securing recesses 13 of the hub 4 until said securing lugs are enclosed in the securing groove 22. The two gearwheels 2, 3 are then rotated in the circumferential direction 5 relative to each other, and therefore the side webs 15 act as axial abutments for the securing lugs 12. The bayonet catch is thereby realized.

During the operation of the gearwheel arrangement, the rotatability of the secondary gearwheel 3 in relation to the main gearwheel 2 is limited. The limiting is obtained by means of the correspondingly dimensioned spring force of the spring ring 6. The angular dimension of the rotatability of the secondary gearwheel 3 is therefore smaller in the circumferential direction 5 than the minimum angular dimension of the bayonet catch, which minimum angular dimension is required for releasing the connection between the two gearwheels. For this purpose, the angular dimension of the rotatability of the secondary gearwheel 3 in the circumferential direction 5 is smaller than would be necessary in order to return the complete angular dimension W of the securing lugs 12, said angular dimension running in the circumferential direction 5, into the associated securing recesses 13.

If the bayonet catch is intended to be released, the secondary gearwheel 3 is rotated relative to the main gearwheel 2 counter to the spring force of the spring ring 6 by means of an auxiliary device (not illustrated here) until the securing lugs 12 are aligned in the axial direction 10 with the securing recesses 13 in such a manner that the secondary gearwheel 3 can be removed axially from the main gearwheel 2.

In the mounting position, the surface of the outer end face or end side 18 of the secondary gearwheel 3, which end face or end side faces away axially from the main gearwheel 2 and the annular gap 8 thereof, is aligned with the axial hub free end 19 of the hub 4. The hub 4 can be of short design axially in such a manner that the securing elements 12, 13, 15, 22 or the bayonet catch are or is positioned axially within the gearwheel arrangement 1. In other words, the securing elements 12, 13, 15, 22 or the bayonet catch are or is arranged axially between the end side 18 of the secondary gearwheel 3 and an end side 26 of the main gearwheel 2. The two end sides 18, 26 mentioned are arranged facing away from each other axially and form the two axially outer faces of the gearwheel arrangement 1. The axially outer end side 18 of the secondary gearwheel 3 extends in a flat plane parallel to the radial direction 14. Only the outer face 29, which runs in the radial direction 14, of the teeth 28 adjoining a main body 30 of the secondary gearwheel 3 optionally at least partially deviates from the plane of the end face or end side 18. In the exemplary embodiment, this deviation is provided in the region of a radially outer teeth bevel 31 of the teeth 28 (FIG. 3, FIG. 4).

In the mounting position and in operational use, the teeth 28 of the secondary gearwheel 3 to a certain extent form an axial extension of the teeth 27 of the main gearwheel 2 (FIG. 2).

For the sake of order, it is pointed out that the components and details illustrated in the drawings are not necessarily illustrated to scale.

1-16. (canceled)

17. A gearwheel arrangement, comprising:
a main gearwheel that has a hub;
a secondary gearwheel that has a receiving hole that receives the hub, wherein the secondary gearwheel is rotatable in a circumferential direction in relation to the main gearwheel, wherein when the gearwheel arrangement is in a mounting position the secondary gearwheel is secured in an axial direction; and
a spring element that pretensions the secondary gearwheel in the circumferential direction, wherein the spring element is completely enclosed within the gearwheel arrangement.

18. The gearwheel arrangement as set forth in claim 17, wherein at least one securing element is located at a hole wall of the receiving hole and wherein at least one securing element is located at an outside of the hub, wherein said securing elements interact with one another in the mounting position to connect the main gearwheel and the secondary gearwheel together in a bayonet catch;
wherein the hub has an axial hub free end, wherein in the mounting position the axial hub free end extends in the axial direction at most as far as a plane of an outer end side of the secondary gearwheel, wherein the outer end side of the secondary gearwheel faces axially away from the main gearwheel when in the mounting position.

19. The gearwheel arrangement as set forth in claim 17, wherein the main gearwheel defines an annular gap, wherein the spring element is a spring ring and is located within the annular gap of the main gearwheel.

20. The gearwheel arrangement as set forth in claim 19, wherein the spring ring has two open ring ends located in the annular gap, wherein one of the open ring ends is supported in the circumferential direction on a supporting web of the main gearwheel, wherein the other one of the open ring ends is supported in the circumferential direction on a supporting web of the secondary gearwheel.

21. The gearwheel arrangement as set forth in claim 17, wherein in the mounting position the rotatability of the secondary gearwheel in the circumferential direction in relation to the main gearwheel is bounded by the spring element.

22. A gearwheel arrangement, comprising:
a main gearwheel that has a hub; and
a secondary gearwheel that has a receiving hole that receives the hub, wherein the secondary gearwheel is rotatable in a circumferential direction in relation to the main gearwheel, wherein when the gearwheel arrangement is in a mounting position the secondary gearwheel is secured in an axial direction;
wherein the hub has an axial hub free end, wherein in the mounting position the axial hub free end extends in the axial direction at most as far as a plane of an outer end side of the secondary gearwheel, wherein the outer end side of the secondary gearwheel faces axially away from the main gearwheel when in the mounting position.

23. The gearwheel arrangement as set forth in claim 22, wherein at least one securing element is located at a hole wall of the receiving hole and wherein at least one securing element is located at an outside of the hub, wherein said securing elements interact with one another in the mounting position to connect the main gearwheel and the secondary gearwheel together in a bayonet catch, and further comprising a spring element that pretensions the secondary gearwheel in the circumferential direction, wherein the spring element is completely enclosed within the gearwheel arrangement.

24. The gearwheel arrangement as set forth in claim 22, wherein the secondary gearwheel has a main body and teeth that are located radially outward from the main body, wherein the outer end side of the secondary gearwheel at least in the main body extends in a single flat plane radially outside the teeth of the secondary gearwheel.

25. The gearwheel arrangement as set forth in claim 22, wherein the main gearwheel and the secondary gearwheel are releasable from one another.

26. A gearwheel arrangement, comprising:
a main gearwheel that has a hub; and
a secondary gearwheel that has a receiving hole that receives the hub, wherein the secondary gearwheel is rotatable in a circumferential direction in relation to the main gearwheel, wherein when the gearwheel arrangement is in a mounting position the secondary gearwheel is secured in an axial direction;
wherein at least one securing element is located at a hole wall of the receiving hole and wherein at least one securing element is located at an outside of the hub, wherein said securing elements interact with one another in the mounting position to connect the main gearwheel and the secondary gearwheel together in a bayonet catch.

27. The gearwheel arrangement as set forth in claim 26, wherein the hub has an axial hub free end, wherein in the mounting position the axial hub free end extends in the axial direction at most as far as a plane of an outer end side of the secondary gearwheel, wherein the outer end side of the secondary gearwheel faces axially away from the main gearwheel when in the mounting position, and further comprising a spring element that pretensions the secondary gearwheel in the circumferential direction, wherein the spring element is completely enclosed within the gearwheel arrangement.

28. The gearwheel arrangement as set forth in claim 26, wherein the at least one securing element at the hole wall is integrally formed with the secondary gearwheel, and wherein the at least one securing element at the outside of the hub is integrally formed with the main gearwheel.

29. The gearwheel arrangement as set forth claim 26, wherein at least one of the securing elements is a securing lug, wherein at least one of the securing elements is a securing groove, and wherein when the gearwheel arrangement is in the mounting position the securing lug is enclosed releasably in the circumferential direction in the securing groove.

30. The gearwheel arrangement as set forth in claim 29, wherein a plurality of the securing lugs are present and are spaced apart from one another in the circumferential direction.

31. The gearwheel arrangement as set forth in claim 29, wherein the securing groove opens axially into a securing recess which is bounded in the circumferential direction by two side webs, wherein the securing recess is at least as large in the circumferential direction as the securing lug.

32. The gearwheel arrangement as set forth in claim 31, wherein a plurality of securing recesses are present and are spaced apart from one another in the circumferential direction.

33. The gearwheel arrangement as set forth in claim 29, wherein at least one of the securing elements is a side web that defines an axial boundary of the securing groove.

34. The gearwheel arrangement as set forth in claim 29, wherein a plurality of the securing lugs are present and are located at the hole wall of the receiving hole.

35. The gearwheel arrangement as set forth in claim 29, wherein the securing groove is located at the outside of the hub and is open radially outward.

36. The gearwheel arrangement as set forth in claim 26, wherein when the gearwheel arrangement is in the mounting position the angular dimension of the rotatability in the circumferential direction is smaller than the angular dimension of the bayonet catch in the circumferential direction in order to release the connection between the main gearwheel and the secondary gearwheel.
